(19) United States
(12) Patent Application Publication
(10) Pub. No.: US 2025/0062478 A1
(43) Pub. Date: Feb. 20, 2025

(54) SPACER AND ASSEMBLED BATTERY

(71) Applicant: Mitsubishi Chemical Corporation, Tokyo (JP)

(72) Inventors: Tomohiro KAWAI, Tokyo (JP); Kei HASHIMOTO, Kawasaki-shi (JP)

(73) Assignee: Mitsubishi Chemical Corporation, Tokyo (JP)

(21) Appl. No.: 18/798,752

(22) Filed: Aug. 8, 2024

Related U.S. Application Data
(60) Provisional application No. 63/532,539, filed on Aug. 14, 2023.

(51) Int. Cl. H01M 50/291; H01M 50/209; H01M 50/233; H01M 50/293

(52) U.S. Cl. CPC H01M 50/291; H01M 50/209; H01M 50/233; H01M 50/293

(57) ABSTRACT

Provided are a spacer and an assembled battery which exhibit good elasticity and pressure resistance, and efficiently transfer heat generated from an adjacent unit battery to a neighboring unit battery in a normal state, and can prevent a chain of damage between unit batteries in an abnormal state in which adjacent unit batteries are damaged and there is a risk that the damage will spread to the entire assembled battery in a chain reaction. The spacer includes a heat conduction control member, a buffer member, and an outer package for housing these members.

### BACKGROUND OF THE INVENTION

### 1. Field of the Invention

The present invention relates to a spacer and an assembled battery.

### 2. Description of Related Art

In recent years, with respect to a secondary battery which is rapidly increasing in use as a power source of a vehicle or the likes, for the purpose of improving the degree of freedom in mounting the secondary battery in a limited space of the vehicle or the likes, the purpose of extending a cruising distance of the vehicle for one charging, or likes, studies on increasing energy density of the secondary battery have been conducted. On the other hand, the safety of the secondary battery tends to be contrary to the energy density, and the safety tends to decrease as the secondary battery has a high energy density. For example, in a secondary battery mounted on an electric vehicle whose cruising distance reaches several hundred kilometers, the battery surface temperature exceeds several hundred ° C. and may reach 1000° C. or higher in some cases when the secondary battery is damaged due to overcharging, internal short circuiting or the likes.

Since a secondary battery used for a power source of a vehicle or the likes is generally used as an assembled battery composed of a plurality of unit batteries, when one of the unit batteries constituting the assembled battery is damaged and reaches the above-described temperature range, adjacent unit batteries are damaged by the heat generation, and there is a possibility that the damage spreads to the entire assembled battery in a chain reaction. In order to prevent such a chain of damage between unit batteries, various techniques have been proposed in which a spacer is provided between unit batteries to cool a damaged unit battery.

For example, there is a module in which a spacer having a configuration in which a coolant such as water is contained in a sheet-shaped bag is installed between unit batteries (for example, PTL 1). According to this module, in addition to efficiently transferring heat generated from an adjacent unit battery to a neighboring unit battery, when an adjacent unit battery is damaged and the surface of the battery reaches a high temperature, water in the bag is discharged from the opening portion, and the damaged battery can be cooled. In addition, there is a spacer having a configuration in which a porous body impregnated with a coolant such as water is put in a sheet-shaped bag (for example, PTL 2).

### CITATION LIST

### Patent Literature

PTL 1: JP 2014-157747 A
PTL 2: JP 2011-108617 A

### SUMMARY OF THE INVENTION

As a result of detailed studies of these conventional techniques by the present inventor, it has been found that the following problems exist. That is, a restraint pressure is applied to the unit batteries in the assembled battery when the assembled battery is manufactured. In addition, since the electrode in the unit battery expands when the unit battery is charged, the housing also expands and presses adjacent members. Further, when the unit battery is repeatedly used, pressure is also applied to the unit battery due to expansion caused by gas generated from the electrolytic solution in the unit battery. For these reasons, the spacer provided between the unit batteries is required to have pressure resistance. However, regarding the spacers disclosed in PTLs 1 and 2, the pressure resistance has not been sufficiently studied.

On the other hand, the present inventor has proposed a spacer including a heat insulating material holding a liquid and an outer package for housing the heat insulating material and the liquid. The spacer has a characteristic that the thermal resistance is switched before and after a temperature (opening temperature) at which the vapor pressure of the liquid exceeds the burst strength of the outer package. At a temperature lower than the opening temperature, a low thermal resistance is exhibited by the liquid held inside the exterior material, on the contrary, at a temperature equal to or higher than the opening temperature, the liquid volatilizes and a high thermal resistance is exhibited by the remaining heat insulating material. Due to this characteristic, the spacer in contact with the unit battery that has undergone abnormal temperature rise due to overcharging, internal short-circuiting opens or the likes, and the high thermal resistance thereof can suppress the heat conduction to the adjacent unit battery. On the other hand, the spacer between the unit batteries other than the unit battery in which an abnormality has occurred has low thermal resistance, and can suppress the temperature rise of each cell due to the heat transfer from the unit battery in which an abnormality has occurred.

Under the above-described circumstances, in a normal state, in order to absorb the expansion of the unit battery and maintain the performance of the unit battery, a spacer is required to exhibit good elasticity and good pressure resistance. On the other hand, in addition to efficiently transferring heat generated from an adjacent unit battery to a neighboring unit battery, it is required to prevent a chain of the temperature rise between the unit batteries in an abnormal state in which the adjacent unit battery causes an abnormal temperature rise and the abnormal temperature rise may spread to the entire assembled battery in a chain reaction.

That is, an object of the present invention is to provide a spacer capable of achieving both performance required in a normal state and performance required in an abnormal state at a high level, and an assembled battery using the spacer.

As a result of intensive studies to solve the above-described problems, the present inventor has found that the above-described problems can be solved by using a spacer of an assembled battery in which a layer for controlling heat conduction and a layer for controlling compressibility are incorporated, and have completed the following present invention. In other words, the present invention is as follows.

[1]A spacer including a heat conduction control member, a buffer member, and an outer package for housing the heat conduction control member and the buffer member.

[2] The spacer according to [1], in which the spacer has a thermal conductivity of 0.25 [W/(m·K)] or more when an average surface temperature of the spacer is 25° C.

[3] The spacer according to [2], in which the spacer has a deformation rate under a pressure of 0.2 MPa of 5 to 50%.

[4] The spacer according to [2] or [3], in which a thickness of the heat conduction control member is equal to or less than a thickness of the buffer member.

[5] The spacer according to any one of [1] to [4], in which the heat conduction control member is made of a composition containing at least one selected from the group consisting of inorganic particles and inorganic fibers and a liquid, or a cured product of the composition.

[6] The spacer according to [5], in which the heat conduction control member further includes a binder.

[7] The spacer according to [5] or [6], in which the heat conduction control member further includes a hydration product.

[8] The spacer according to any one of [5] to [7], in which a content of the liquid is 1 to 90% by mass with respect to a total mass of the composition.

[9] The spacer according to any one of [5] to [8], in which the liquid is water.

[10] The spacer according to any one of [5] to [9], in which the inorganic particles are at least one selected from the group consisting of calcium silicate and zeolite.

[11] The spacer according to any one of [5] to [10], in which the buffer member is a sheet-shaped member and has a concave portion and/or a penetration portion, and the concave portion and/or the penetration portion is provided with the composition or a cured product thereof.

[12] The spacer according to any one of [5] to [11], in which the buffer member is a tray-shaped member having a plurality of concave portions, and the concave portions are filled with the composition.

[13] The spacer according to any one of [1] to [12], in which the buffer member is made of a thermoplastic polymer.

[14] The spacer according to [13], in which the thermoplastic polymer is an olefin polymer.

[15] The spacer according to [14], in which the olefin polymer is polypropylene.

[16] An assembled battery including: a plurality of unit batteries; and the spacer according to any one of [1] to [15] between the unit batteries.

[17] The assembled battery according to [16], in which when the unit battery thermally expands, the unit battery comes into contact with the buffer member and the heat conduction control member of the spacer in this order via the outer package.

[18]A spacer including a heat insulating material precursor and an outer package for housing the heat insulating material precursor.

[19] The spacer according to [18], in which the heat insulating material precursor contains at least one selected from the group consisting of inorganic particles and inorganic fibers, and a liquid.

[20] The spacer according to [18] or [19], in which the heat insulating material precursor becomes a heat insulating material by heating.

[21] An assembled battery including a plurality of unit batteries and a member disposed between the unit batteries, in which a portion between two unit batteries includes a unit satisfying the following conditions (1) and (2):
(1) an average surface temperature of the two unit batteries is 50 to 200° C., and a thermal conductivity decreases to less than 1.0 times;
(2) a deformation rate of the member disposed between the two unit batteries is 5 to 50% with respect to a pressure of 0.2 MPa applied between the two unit batteries.

[22] The assembled battery according to [21], in which the member disposed between the unit batteries includes a heat conduction control member.

[23] The assembled battery according to [21] or [22], in which the member disposed between the cells includes a heat insulating material precursor.

[24]A heat insulation method including: disposing a spacer including a heat insulating material precursor containing at least one selected from the group consisting of inorganic particles and inorganic fibers and a liquid; and converting the heat insulating material precursor into a heat insulating material.

According to the present invention, it is possible to propose a spacer and an assembled battery which exhibit good elasticity and pressure resistance, and efficiently transfer heat generated from an adjacent unit battery to a neighboring unit battery in a normal state, and can prevent a chain of damage between unit batteries in an abnormal state in which adjacent unit batteries are damaged and there is a risk that the damage will spread to the entire assembled battery in a chain reaction.

### BRIEF DESCRIPTION OF THE DRAWINGS

FIG. 1 is a photograph showing an embodiment of the buffer member in the present invention.

FIG. 2 is a conceptual diagram showing an example of the spacer of the present invention.

FIG. 3 is a conceptual diagram showing another example of the spacer of the present invention.

FIGS. 4A to 4C are conceptual diagrams showing an example of the structure of the heat conduction control member and the buffer member of the spacer of the present invention.

FIGS. 5A and 5B are conceptual diagrams showing an example of the structure of the heat conduction control member and the buffer member of the spacer of the present invention.

FIG. 6 is a conceptual diagram showing an assembled battery of the present invention.

FIG. 7 is a plan view showing an example of a unit battery.

FIG. 8 is a front view of the unit battery of FIG. 7.

FIG. 9 is a side view of the unit battery of FIG. 7.

FIG. 10 is a conceptual diagram of a heat insulation evaluation apparatus.

### DESCRIPTION OF EMBODIMENTS

Hereinafter, an example of an embodiment of the present invention will be described in detail. However, the present invention is not limited to the embodiment described below, and can be arbitrarily modified and implemented within a range not departing from the gist of the present invention.

In the specification herein, when it is described as “X to Y” (X and Y are arbitrary numbers), it includes the meaning of “X or more and Y or less” and also includes the meaning of “preferably larger than X” or “preferably smaller than Y” unless otherwise specified. In addition, when it is described as “X or more” (X is an arbitrary number), it includes the meaning of “preferably more than X” unless otherwise specified, and when it is described as “Y or less” (Y is an arbitrary number), it also includes the meaning of “preferably less than Y” unless otherwise specified.

The “abnormal state” means a state in which the average surface temperature of the unit battery or the spacer has reached 200° C. or higher. The temperature of the unit battery may increase due to the chemical substances contained in the electrodes, the electrolytic solution or the likes constituting the unit battery causing decomposition reactions while generating heat inside the unit battery.

The “average surface temperature” means an average temperature of any three points in contact with a heating element on the spacer surface.

### Spacer

The spacer of the present invention is a member which has a thickness direction and a plane direction orthogonal to the thickness direction, and which partitions between unit batteries or between a unit battery and a member other than the unit battery in the thickness direction. Here, the “member other than the unit battery” is, for example, a housing which has a bottom surface and four side surfaces, and which houses the unit batteries and the spacer constituting the assembled battery.

One embodiment of the present invention is a spacer including a heat conduction control member, a buffer member, and an outer package for housing the heat conduction control member and the buffer member. Here, the heat conduction control member and the buffer member may have a layered structure, and in this case, they are respectively referred to as a “heat conduction control layer” and a “buffer layer”. Each of these members (layers) may have a plurality of layers in one spacer.

### Heat Conduction Control Member

The spacer of the present invention is characterized by having a heat conduction control member. The heat conduction control member means a member that changes from a state of high thermal conductivity to a state of low thermal conductivity.

The member has high thermal conductivity and can efficiently transfer heat generated from an adjacent unit battery to a neighboring unit battery in a normal state, and changes to a state of low thermal conductivity to suppress the transfer of heat to the adjacent unit battery in an abnormal state.

For the heat conduction control member, one kind of material whose thermal conductivity changes may be used. For example, a material whose thermal conductivity changes due to a volume change caused by a temperature rise, such as a foamed material, may be used. In addition, a material whose thermal conductivity changes due to a phase change caused by a temperature rise may be used.

As a method different from the above, there is a method of using two or more kinds of materials having different thermal conductivities for the heat conduction control member. A specific material may be designed to have a dominant thermal conductivity at a specific timing. For example, a high thermal conductive material and a low thermal conductive material may be used, and the low thermal conductive material may be designed to be coated or impregnated in the high thermal conductive material. If the high thermal conductive material melts, evaporates, or sublimates at a specific temperature, the thermal conductivity of the low thermal conductive material becomes dominant. In this case, the spacer has a decreased thermal conductivity at a specific temperature. By such a mechanism, it is possible to control the temperature at which the thermal conductivity of the spacer decreases and the thermal conductivity before and after the change.

The heat conduction control member is preferably formed of a composition containing a liquid and at least one selected from the group consisting of inorganic particles and inorganic fibers (hereinafter may be simply referred to as a “composition”) or a cured product thereof. It is more preferable that the heat conduction control member further includes a binder, and it is more preferable that the heat conduction control member further includes a hydration product.

In the present invention, it is particularly preferable to use an inorganic particle paste. The inorganic particle paste is made into a paste form of inorganic particles and a liquid, and the liquid contained in the inorganic particle paste can absorb vaporization heat from the surroundings by evaporating when one of the unit batteries abnormally generates heat, and can suppress an increase in temperature by the vaporized gas escaping, and can also release heat by the escape of the vaporized gas.

On the other hand, an embodiment in which inorganic particles are used and a liquid is not used may be adopted, and by constituting the spacer in combination with the buffer member and the outer package, it is possible to absorb the expansion of the unit battery while being a powder. In addition, the spacer has high pressure resistance, and does not rupture when the unit battery expands and the likes.

### Inorganic Particles and Inorganic Fibers

The inorganic particles are not particularly limited as long as the effects of the present invention are exhibited, and examples thereof include silica particles, alumina particles, calcium silicate, zeolite, diatomaceous earth, Shirasu balloons, clay minerals, vermiculite, mica, cement, pearlite, fumed silica, and aerogel. Among these, silica particles, alumina particles, calcium silicate, zeolite, and vermiculite are preferable, and it is particularly preferable to contain one selected from the group consisting of calcium silicate and zeolite from the viewpoint that a larger amount of liquid is easily contained in the particles and between the particles.

Further, among the types of calcium silicate, xonotlite, tobermorite, wollastonite, and gyrolite are preferable, and gyrolite is particularly preferable. Gyrolite having a petal-like structure has excellent water retention because it maintains a porous structure even when compressed and deformed. Clay minerals are mainly magnesium silicate (including talc and sepiolite), montmorillonite, and kaolinite. The particle diameter of the inorganic particles is preferably ⅕ or less of the thickness of a layer when the heat conduction control member is in the form of a layer (hereinafter, may be referred to as a “heat conduction control layer”). These inorganic particles can be used alone or in a state of being mixed with a plurality of kinds thereof.

The inorganic fibers are not particularly limited as long as the effects of the present invention are exhibited, and examples thereof include inorganic fibers such as glass fibers, alumina fibers, and rock wool. As the fiber system of the inorganic fibers, a fiber diameter of ⅕ or less of the thickness of the heat conduction control layer is preferable. These inorganic fibers can be used alone or in a state of being mixed with a plurality of kinds thereof.

When the inorganic fibers are formed into a paste together with the liquid, the fiber diameter and the fiber length are not particularly limited, and may be any fiber diameter and fiber length that can be formed into a paste. In general, the fiber diameter is small to some extent, and the fiber length is short to some extent, which is advantageous for forming a paste.

The inorganic particles and the inorganic fibers may be used in combination.

In addition, the content of the inorganic particles and the inorganic fibers in 100% by mass of the composition is preferably 3 to 70% by mass, more preferably 3 to 50% by mass, still more preferably 3 to 30% by mass, and particularly preferably 3 to 10% by mass.

In addition, the ratio of the content of the liquid to the content of the inorganic particles and the inorganic fibers is preferably 1 to 30, more preferably 2 to 20, and still more preferably 5 to 15.

### Binder

The binder contained in the heat conduction control member means a material that is hardened by a hydration reaction. The type of the binder is not particularly limited, and examples thereof include gypsum and a hydraulic material.

Examples of the gypsum include natural gypsum such as gypsum dihydrate and gypsum hemihydrate, and chemical gypsum such as gypsum phosphate, flue-gas desulfurization gypsum, titanium gypsum, smelted gypsum, and fluorogypsum, and natural gypsum is preferable, and calcium sulfate is more preferable.

Examples of the hydraulic material include portland cement, mixed cement, alumina cement, quicklime, slaked lime, and mixtures thereof, and alumina cement is preferable.

From the viewpoint of controlling the hardening time, two or more kinds of binders may be mixed, and it is preferable to mix gypsum and a hydraulic material.

The content of the binder (total content in a case where two or more kinds of the binders are included) in 100% by mass of the composition is preferably 1 to 70% by mass, more preferably 10 to 50% by mass, and still more preferably 20 to 40% by mass.

In a case where gypsum and a hydraulic material are used in combination, it is preferable that 15 to 40% by mass of gypsum and 5 to 30% by mass of a hydraulic material are respectively contained in 100% by mass of the composition.

### Liquid

The liquid for making the particles into a paste may be any liquid that has thermal conductivity and can efficiently transfer heat generated from the unit battery to the neighboring unit battery. In addition, as the liquid, a liquid having a boiling point of 80° C. or higher and 250° C. or lower at normal pressure (1 atm) is preferable, and a liquid having a boiling point of 100° C. or higher and 150° C. or lower at normal pressure is more preferable.

As the liquid, for example, it is preferable to include at least one selected from the group consisting of water, alcohols, esters, ethers, ketones, hydrocarbons, fluorine-based compounds, and silicone-based oils. These can be used alone or as a mixture of two or more kinds thereof. In addition, water is particularly preferable as the liquid from the viewpoint of having a large vaporization heat and being widely available.

Examples of alcohols that can be used for the liquid include alcohols containing 3 to 8 carbon atoms, such as propanol, isopropanol, butanol, benzyl alcohol, and phenylethyl alcohol; alkylene glycols such as ethylene glycol and propylene glycol; and dihydric or higher-valent alcohols such as glycerin. These can be used alone or as a mixture of two or more kinds thereof.

Examples of esters that can be used for the liquid include alkyl aliphatic carboxylic esters, alkyl carbonic diesters, alkyl oxalic acid diesters, and fatty acid esters of ethylene glycol. These can be used alone or as a mixture of two or more kinds thereof.

Examples of ethers that can be used for the liquid include n-butyl ether, n-propyl ether, and isoamyl ether. These can be used alone or as a mixture of two or more kinds thereof.

Examples of ketones that can be used for the liquid include methyl ethyl ketone and diethyl ketone. These can be used alone or as a mixture of two or more kinds thereof.

Examples of hydrocarbons that can be used for the liquid include heptane, octane, nonane, decane, toluene, and xylene. These can be used alone or as a mixture of two or more kinds thereof.

Examples of the fluorine-based compound that can be used for the liquid include 1,1,2,2,3,3,4-heptafluorocyclopentane (HFC-c447ef) and 1,1,1,2,2,3,3,4,4,5,5,6,6-tridecafluorooctane (HFC-76-13sf) which are refrigerants. These can be used alone or as a mixture of two or more kinds thereof.

Examples of the silicone-based oil that can be used for the liquid include modified silicone oils such as methylpolysiloxane, methylphenylpolysiloxane, cyclic methylsiloxane, and silicone polyether copolymer. These can be used alone or as a mixture of two or more kinds thereof.

In addition, the liquid may contain additives such as an antifreeze agent, a preservative, a pH adjuster, and a surfactant. By adding the surfactant, the inorganic particle paste or the inorganic fiber paste can be uniformly filled in the tray-shaped member. Further, the liquid may contain a gelling agent and be in the form of a gel. The above-described additives may be used alone or as a mixture of two or more kinds thereof. What is included in the liquid is not limited to this, and can be added as necessary.

The content of the liquid is preferably 1 to 90% by mass with respect to the total mass of the composition.

The above-described heat conduction control member is included in an outer package described later, but when the inorganic particle paste or the powdery inorganic particles are used, it is preferable to have a member for holding the inorganic particle paste or the powdery inorganic particles. The member is preferably a tray-shaped member having a function as a buffer member described later.

### Buffer Member

The buffer member in the present invention is a material that absorbs expansion accompanying charging of the unit battery in a normal state, expansion accompanying deterioration of the unit battery, expansion when the battery is used at high temperatures, and the likes. The buffer member is preferably a sheet-shaped member. The sheet-shaped member has a concave portion and/or a penetration portion, and the concave portion and/or the penetration portion is preferably provided with the composition or a cured product thereof. In an aspect in which the composition or the cured product thereof is provided in the penetration portion, the composition preferably has a viscosity to the extent that the composition can remain in the penetration portion, or the composition is preferably a cured product.

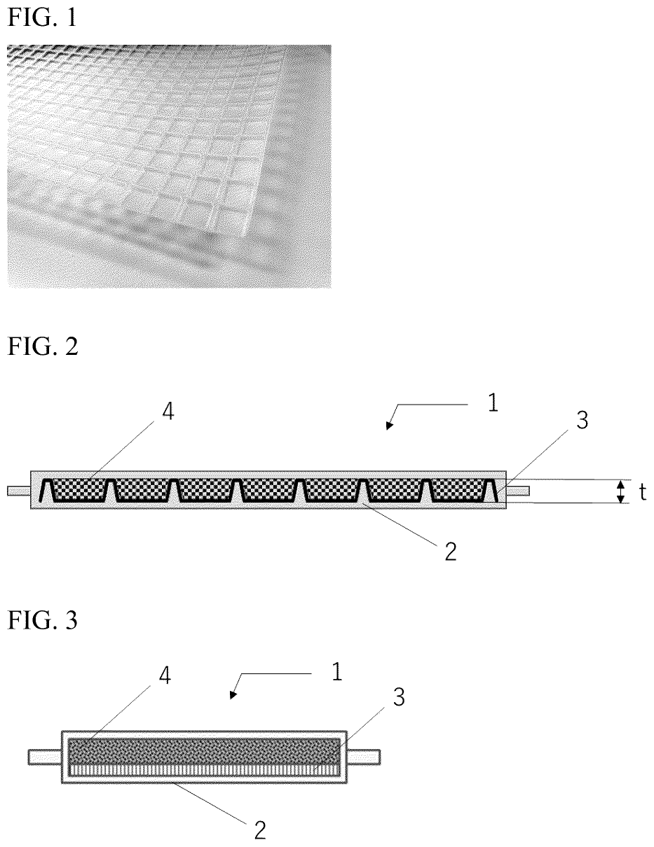

More specifically, a tray-shaped member having a plurality of concave portions as shown in FIG. 1 (hereinafter sometimes referred to as a “tray-shaped member”) can be mentioned. The presence of such a concave portion is preferable because the above-described inorganic particles or inorganic particle paste can be held. Further, by using the buffer member, the compression characteristics can be controlled as a spacer while using the inorganic particles, the inorganic fibers, the inorganic particle paste, and the inorganic fiber paste, which is preferable.

That is, the tray-shaped member has a function of filling and holding the inorganic particles or the inorganic particle paste suitable as the heat conduction control layer in the concave portion of the tray-shaped member, and has a function as a buffer member.

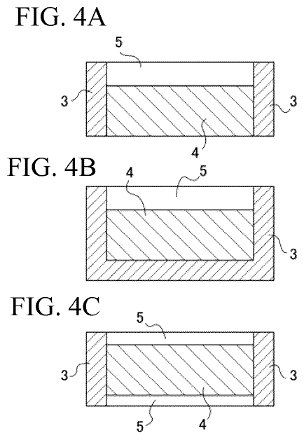

In the present invention, even in an aspect in which the tray-shaped member is filled with the inorganic particle paste or the likes, the tray-shaped member is defined as a buffer member, and the inorganic particle paste or the likes filled in the concave portion thereof is defined as a heat conduction control member. In addition, the concave portion of the tray-shaped member may be filled with the inorganic particles (powder form) or the inorganic particle paste so as to be full (see FIG. 2), or may be filled up to a part of the depth of the concave portion (see FIGS. 4A to 4C). In addition, all the concave portions may not be filled with the inorganic particles or the inorganic particle paste. Furthermore, as long as the tray-shaped member, the inorganic particles and the likes are loaded in the outer package, the inorganic particles and the likes may be in a state of overflowing from the concave portion of the tray-shaped member (see FIG. 3).

The size of the concave portion of the tray-shaped member is not particularly limited as long as the effects of the present invention are exhibited, but for example, the area of the concave portion with respect to the entire area when the tray-shaped member is viewed in a plan view is preferably in a range of 5 to 99%, more preferably in a range of 10 to 95%, and still more preferably in a range of 20 to 90%. When the area of the concave portion is equal to or greater than the lower limit value, a sufficient amount of the inorganic particle paste and the likes can be held in the concave portion, and thus the control of heat conduction and the heat insulation effect are maintained. On the other hand, when the area of the concave portion is equal to or less than the upper limit value, sufficient strength of the tray-shaped member is secured, and favorable elasticity is obtained. In addition, when the area of the concave portion is equal to or less than the upper limit value, when the spacer is pressurized, the internal pressure of the spacer is less likely to increase, and the pressure resistance of the spacer becomes favorable.

The depth of the concave portion is not particularly limited, but is preferably in a range of 0.1 to 20 mm, more preferably in a range of 0.5 to 10 mm, and still more preferably in a range of 0.8 to 7 mm. When the depth of the concave portion is equal to or greater than the lower limit value, a sufficient amount of the inorganic particle paste and the likes can be held in the concave portion, and thus the control of heat conduction and the heat insulation effect are maintained. On the other hand, when the depth of the concave portion is equal to or less than the upper limit value, sufficient strength of the tray-shaped member is secured, favorable elasticity is obtained, and the assembled battery can be made compact. In addition, when the depth of the concave portion is equal to or less than the upper limit value, expansion of the unit battery can be absorbed more.

The shape of the concave portion is not particularly limited, and may be a square shape as shown in FIG. 1, a rectangular shape such as a rectangle or a rhombus, a circular shape, an elliptical shape, a honeycomb shape, or the likes. Further, the shapes of the concave portions may not be all the same, but may be a combination of different shapes.

In addition, the number of concave portions is also not particularly limited, and is not particularly limited as long as the concave portions have the above-described area ratio. In general, the number of concave portions per unit areal size (1 cm²) is preferably about 0.1 to 5, and more preferably in a range of 0.25 to 2.

The thickness (sheet thickness) of the tray-shaped member is preferably in a range of 50 to 1000 μm, and more preferably in a range of 100 to 500 μm. When the thickness of the tray-shaped member is equal to or greater than the lower limit value, sufficient elasticity can be obtained. On the other hand, when the thickness of the tray-shaped member is equal to or less than the upper limit value, the thickness of the spacer can be reduced, the ratio occupied by the unit batteries increases, and thus the energy efficiency can be improved. Further, the assembled battery can be made compact.

In addition, the concave portion may have a through hole in the member thickness direction. In general, the ratio of the area occupied by the through holes to the area of the concave portion is preferably about 10 to 100%, and more preferably 50 to 90%. Since the through holes are present, more inorganic particle paste and the likes can be held, and the control of heat conduction and the heat insulation effect can be obtained more highly. In general, when the ratio of the area occupied by the through holes to the area of the concave portion is equal to or greater than the lower limit, higher control of heat conduction and higher heat insulation effect are obtained, and when the ratio is equal to or less than the upper limit, the retention of the inorganic particle paste and the likes in the tray-shaped member is improved.

The material of the buffer member represented by the tray-shaped member is preferably a thermoplastic polymer from the viewpoint of having good elasticity and excellent processability, and examples thereof include olefin polymers such as polyethylene and polypropylene, polyester resins such as polyethylene terephthalate (PET) and polyethylene naphthalate (PEN), polystyrene (PS), and the likes. Silicone rubber and foams thereof can also be used. Among these, from the viewpoint of versatility, cost and the likes, olefin polymers are preferable, and polypropylene is particularly preferable. These resins may contain a heat-resistant filler such as alumina particles or glass fibers.

The method for producing the tray-shaped member is not particularly limited, but for example, a method for producing the tray-shaped member by preparing a sheet of a resin such as polypropylene and performing vacuum molding or press molding, injection molding in which a mold of the tray-shaped member is prepared and a molten resin is poured, or the likes, are suitably used.

### Outer Package

The outer package has a sealed peripheral edge portion, and houses the heat conduction control member and the buffer member in an internal space formed by the sealing. The outer package has flexibility and is deformable in accordance with the expansion of the unit battery. In addition, the outer package is capable of returning to an original state when the unit battery is contracted. Specifically, when the battery is charged and expands, it is compressed so as to absorb the expansion, and when the battery is discharged and contracts, it returns to its original state.

As the outer package, a resin sheet or a resin film can be used, and for example, two or two-fold resin sheets or resin films sandwich the heat conduction control member and the buffer member, and the peripheral edge portion of the outer package where the two resin sheets or resin films are in contact is thermally fused or bonded to seal the heat conduction control member and the buffer member.

As the outer package, for example, a resin-made or metal-made one can be used. A metal foil-resin laminate is preferable because of its high heat resistance and strength. As the metal-resin laminate, a laminate of three or more layers including a resin layer, a metal layer, and a resin sealant layer is preferable.

The metal constituting the metal foil is preferably at least any one of aluminum, copper, tin, nickel, stainless steel, lead, a tin-lead alloy, bronze, silver, iridium, and phosphor bronze. Specific examples thereof include an aluminum foil, a copper foil, a tin foil, a nickel foil, a stainless steel foil, a lead foil, a tin-lead alloy foil, a bronze foil, a silver foil, an iridium foil, and a phosphor bronze foil. In particular, an aluminum foil, a copper foil, and a nickel foil are preferable, and an aluminum foil is still more preferable.

As the resin, at least one of a thermosetting resin and a thermoplastic resin can be used, but a thermoplastic resin is particularly preferable. Examples of the resin include polyethylene, polypropylene, polystyrene, nylon, acrylic, an epoxy resin, polyurethane, polyetheretherketone, polyethylene terephthalate, polyphenylsulfide, polycarbonate, and aramid. In particular, at least one selected from polypropylene, nylon, and polyethylene terephthalate is preferable.

The thickness of the outer package is not particularly limited, but is, for example, 5 μm to 200 μm. In the case of the laminate (laminate body) described above, the thickness of the metal foil can be 3 μm to 50 μm, and the thickness of the resin layer can be 2 μm to 150 μm. This allows the heat resistance and the low water vapor permeability of the metal foil to be exhibited, and the sealing properties to be improved by the resin.

Further, in the outer package, the heat conduction control member and the buffer member are sealed in the outer package by annularly joining the peripheral edge portions of the two outer package by thermal fusion, adhesion or the likes. Alternatively, one outer package may be folded and the peripheral edge portions may be joined by thermal fusion bonding, adhesive bonding or the likes, and the heat conduction control member and the buffer member may be sealed. The outer package preferably has flexibility (elasticity), but may not have flexibility.

The internal air pressure of the outer package is preferably lower than the external air pressure from the viewpoint of sufficiently increasing the opening temperature. Therefore, it is particularly preferable to perform vacuum sealing when the outer package is sealed.

### Heat Insulating Material Precursor

Another embodiment of the present invention is a spacer including a heat insulating material precursor and an outer package for housing the heat insulating material precursor.

The heat insulating material precursor means a material in a stage before the heat insulating material is produced, and is preferably a material which becomes the heat insulating material by heating.

The heat insulating material precursor preferably contains at least one selected from the group consisting of inorganic particles and inorganic fibers, and a liquid. The inorganic particles and the inorganic fibers are the same as those described for the inorganic particles and the inorganic fibers described above. The liquid is the same as described above.

In addition, the heat insulating material precursor may further contain a binder, and the binder is the same as described above.

### Characteristics

The characteristics of the spacer are described below. The location of the spacer is not particularly limited, but the spacer is usually disposed between the unit batteries or between the assembled batteries.

A spacer according to one embodiment of the present invention includes a heat conduction control member, a buffer member, and an outer package for housing the heat conduction control member and the buffer member.

The thermal conductivity of the spacer at a certain temperature is determined by the heat conduction control member. In a normal state, from the viewpoint of heat transfer from the unit battery in contact with the spacer, the thermal conductivity of the spacer is preferably 0.25 [W/(m·K)] or more when the average surface temperature of the spacer is 25° C. In an abnormal state, from the viewpoint of heat insulation from the unit battery in contact with the spacer, when the average surface temperature of the spacer is 50 to 200° C., the thermal conductivity of the spacer is preferably less than 0.25 [W/(m·K)], more preferably less than 0.20 [W/(m·K)], still more preferably less than 0.15 [W/(m·K)], and particularly preferably less than 0.10 [W/(m·K)].

The deformation rate of the spacer at a certain pressure is determined by the type of the buffer member and the arrangement of the buffer member and the heat conduction control member. One of ordinary skill in the art can design the spacer to have any deformation rate at any pressure. From the viewpoint of buffering a restraint pressure at the time of producing the assembled battery, it is preferable that the deformation rate of the spacer under a pressure of 0.2 MPa is 5 to 50%.

It is preferable that the arrangement is designed so that the unit battery is in contact with the buffer member of the spacer first and then the heat conduction control member in this order via the outer package from the viewpoint of greatly buffering against a restraint pressure at the time of producing the assembled battery, and it is more preferable that the thickness of the heat conduction control member is equal to or less than the thickness of the buffer member.

As shown in FIG. 4A, the thickness of the buffer member 3 is not particularly limited, but is preferably equal to or larger than the thickness of the heat conduction control member 4, and more preferably exceeds the thickness of the heat conduction control member 4.

A spacer according to another embodiment of the present invention includes a heat insulating material precursor and an outer package for housing the heat insulating material precursor. The spacer may further include a buffer member. The heat insulating material precursor may be designed to have similar characteristics to the heat conduction control member. The heat insulating material precursor can be used in a method including converting the precursor into a heat insulating material.

### Assembled Battery

Another embodiment of the present invention is an assembled battery including a plurality of unit batteries and the spacer. More specifically, as shown in FIG. 6, a plurality of unit batteries 200 and spacers 1 for partitioning the unit batteries 200 are stacked and housed in, for example, a housing 300. The spacer 1 is provided at least between the unit batteries 200 constituting the assembled battery 100 so that the unit batteries 200 do not come into contact with each other. The spacer can also be used as a spacer (1A) for partitioning the unit battery 200 from another member (the bottom portion of the housing in FIG. 6) in addition to between the unit batteries 200.

In a unit structure including two unit batteries and a spacer disposed between the two unit batteries, the two unit batteries are preferably in contact with the buffer member via an outer package, and the two unit batteries are more preferably in contact with only the buffer member via an outer package.

When the unit battery expands, it is preferable that the unit battery is in contact with the buffer member of the spacer first and then the heat conduction control member in this order via the outer package.

As described above, the spacer 1 is composed of the heat conduction control member, the buffer member, and the outer package for housing these members. The compressive modulus in the thickness direction of the spacer is preferably in a range of 0.1 to 20 MPa. By setting the compressive modulus to 0.1 MPa or more, appropriate stress is applied to the unit battery cell, and the unit battery cell can be reliably fixed. From the above viewpoint, the compressive modulus is preferably 0. 2 MPa or more, and more preferably 0. 5 MPa or more. On the other hand, the upper limit is preferably 20 MPa or less, more preferably 15 MPa or less, and still more preferably 10 MPa or less from the viewpoint of making it possible to extend the life of the cell because the stress in the expansion during the charging and discharging and further the expansion during the aging degradation can be absorbed.

The compressive modulus (23° C.) is generally a value measured in accordance with JIS K7181, but in the present invention, the compressive modulus (23° C.) is a value evaluated by measuring the pressure and the thickness of the spacer when a pressure is applied so that the thickness of the spacer becomes about 95% to 50% of the thickness at the time of non-pressurization, and calculating the ratio to the thickness at the time of non-pressurization.

The spacer can be used as it is for partitioning between the unit batteries or between the unit battery and other members, but in order to facilitate fixing when partitioning between the unit batteries or between the unit battery and other members, an adhesive or a double-sided tape may be attached to the surface thereof, or a resin piece may be attached to the surface thereof.

Another embodiment of the present invention is an assembled battery including a plurality of unit batteries and a member disposed between the unit batteries, in which a portion between two unit batteries includes a unit satisfying the following conditions (1) and (2):
(1) an average surface temperature of the two unit batteries is 50 to 200° C., and a thermal conductivity decreases to less than 1.0 times;
(2) a deformation rate of the member disposed between the two unit batteries is 5 to 50% with respect to a pressure of 0.2 MPa applied between the two unit batteries.

The condition (1) means that the temperature at which the thermal conductivity of the spacer is decreased by less than 1.0 times is any temperature at which the average surface temperature of the unit battery is 50 to 200° C. The thermal conductivity of the condition (1) is preferably decreased by 0.01 to 0.9 times, more preferably decreased by 0.01 to 0.8 times, still more preferably decreased by 0.01 to 0.7 times, and particularly preferably decreased by 0.01 to 0.6 times.

In view of satisfying the condition (1), it is preferable that the member disposed between the batteries includes a heat conduction control member. In this embodiment, it is preferable to design the heat conduction control member so that the thermal conductivity changes when the average surface temperatures of the two unit batteries are 50 to 200° C.

In addition, from the viewpoint of satisfying the condition (1), it is preferable that the member disposed between the batteries includes a heat insulating material precursor. In this embodiment, it is preferable to design the heat insulating material precursor so as to be converted into the heat insulating material when the average surface temperatures of the two unit batteries are 50 to 200° C.

In addition, the deformation rate of the member disposed between the unit batteries with respect to a pressure of 0.2 MPa applied between the unit batteries is preferably 10% to 50% and more preferably 15% to 50%.

In addition, the deformation rate of the member disposed between the unit batteries with respect to a pressure of 1.0 MPa applied between the unit batteries is preferably 10% to 70%, more preferably 15% to 70%, still more preferably 20% to 70%, and particularly preferably 40% to 70%.

### Unit Battery

The unit battery is preferably, for example, a lithium ion secondary battery including a positive electrode and a negative electrode capable of occluding and releasing lithium ions, and an electrolyte. In addition to the lithium ion secondary battery, secondary batteries such as a lithium ion all-solid-state battery, a nickel-hydrogen battery, a nickel-cadmium battery, and a lead acid battery can be applied.

In addition, as the type of the unit battery, a rectangular unit battery, a pouch-shaped unit battery, a cylindrical unit battery and the likes can be applied regardless of the type of the battery.

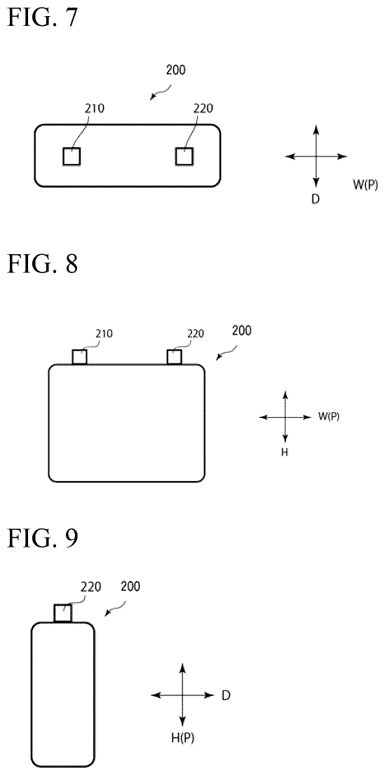

FIG. 7 is a plan view showing an example of a unit battery 200 constituting an assembled battery, FIG. 8 is a front view of the unit battery 200 shown in FIG. 7, and FIG. 9 is a right side view of the unit battery 200. The unit battery 200 is formed in a rectangular parallelepiped shape having a height direction (H), a width direction (W), and a thickness direction (D), and a terminal 210 and a terminal 220 are provided on an upper surface thereof.

The assembled battery according to the present embodiment as described above is applied to a battery pack mounted on, for example, electric vehicles (EV), hybrid electric vehicles (HEV), plug-in hybrid electric vehicles (PHEV), electric heavy machines, electric motorcycles, electrically assisted bicycles, ships, airplanes, trains, uninterruptible power supplies (UPS), household power storage systems, and storage battery systems for power system stabilization using renewable energies such as wind power, solar power, tidal power, and geothermal power. However, the assembled battery can also be used as a power source for supplying electric power to devices other than the above-described EV and the like.

### EXAMPLE

### Evaluation Method

### Evaluation Method 1 (Heat Insulation)

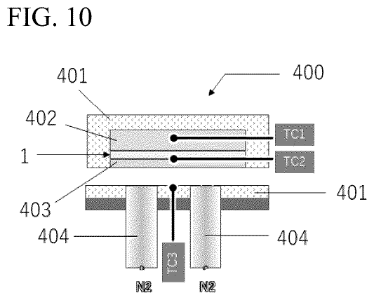

The spacers produced in Examples and Comparative Examples were evaluated for heat insulation by using a test apparatus 400 shown in FIG. 10. Specifically, a spacer 1 was placed on a brass metal plate 403 having a thickness of 1 mm, and a brass metal block 402 having a thickness of 5 mm was set on the upper portion of the spacer 1. The metal plate 403, the spacer 1, and the metal block 402 were covered with a heat insulating material 401 except for the lower portion of the metal plate 403. Nitrogen gas at 300° C. heated by two tube heaters 404 was blown to the metal plate 403 from below, and the temperature of the metal block positioned above the spacer 1 was measured. (Note TC1, TC2 and TC3 in FIG. 10. are thermocouples.)

### Evaluation Method 2 (Compressive Modulus)

The spacers produced in Examples and Comparative Examples were subjected to actual evaluation of the thicknesses thereof when a pressure of 1.4 MPa was applied in Examples 1-1 to 1-3 and a pressure of 1.5 MPa was applied in Comparative Example 1-1, and the compressive modulus was evaluated by calculating the ratio to the thickness when no pressure was applied.

### Example 1-1

Using a 0.3 mm polypropylene sheet, a tray-shaped member as shown in FIG. 1 was produced by a vacuum molding method. The shape of the lowest portion of the concave portion was a square of 7.79 mm×7.79 mm, and the depth was 2 mm. The area ratio of the concave portion when seen from a plan view was 61% with respect to the entire area. The tray-shaped member had a length of 60 mm and a width of 120 mm.

Next, as shown in FIG. 2, a calcium silicate paste (inorganic particle paste 4) was filled in the concave portion of a tray-shaped member 3, and the tray-shaped member was disposed in an aluminum laminate film (including polyethylene terephthalate (outer side) having a thickness of 0.012 mm, nylon (inner side) having a thickness of 0.015 mm, and polypropylene (innermost side) having a thickness of 0.06 mm as resin layers) as an outer package 2, and sealed (closed) using a vacuum deaeration sealer to obtain a spacer. The thickness of the entire spacer was 2.5 mm.

The spacer thus produced was evaluated by the above-described evaluation methods. The evaluation results are shown in Table 1. The calcium silicate paste was prepared as follows.

### (Calcium Silicate Paste)

0.87 g of calcium silicate was added to 9.13 g of water, and the mixture was kneaded with a stirring rod at room temperature for 5 minutes to obtain a calcium silicate paste.

### Example 1-2

A spacer was obtained in the same manner as in Example 1-1, except that a zeolite paste prepared by using 4.2 g of zeolite 13X and 5.3 g of water instead of calcium silicate was used in Example 1-1. The results of the evaluation performed in the same manner as in Example 1-1 are shown in Table 1.

### Example 1-3

A spacer was obtained in the same manner as in Example 1-1, except that a zeolite paste prepared by using 5.0 g of zeolite 4A and 5.3 g of water instead of calcium silicate was used in Example 1-1. The results of the evaluation performed in the same manner as in Example 1-1 are shown in Table 1.

### Comparative Example 1-1

A porous sheet (calcium silicate paper, 118 mm in length, 61 mm in width, and 1.8 mm in thickness) as a heat insulating material was disposed in an aluminum laminate film (including polyethylene terephthalate (outer side) having a thickness of 0.012 mm, nylon (inner side) having a thickness of 0.015 mm, and polypropylene (innermost side) having a thickness of 0.06 mm as resin layers) as an outer package. After the heat insulating material was disposed in the outer package, it was impregnated with 5.0 g of water and then sealed (closed) using a vacuum deaeration sealer to obtain a spacer. The thickness of the entire spacer was 2.0 mm. The results of the evaluation performed in the same manner as in Example 1-1 are shown in Table 1.

TABLE 1

| | | | | | | Comparative |
|---|---|---|---|---|---|---|
| | | | Example 1-1 | Example 1-2 | Example 1-3 | Example 1-1 |
| Heat | Inorganic particles | | Calcium | Zeolite 13X | Zeolite 4A | — |
| conduction | | | silicate | | | |
| control layer | Liquid | | Water | Water | Water | Water |
| Evaluation 1 | Temperature | 400 sec | 97 | 82 | 82 | 97 |
| | (° C.) | 800 sec | 100 | 100 | 100 | 105 |
| | | 1200 sec | 100 | 123 | 110 | 139 |

| | | | | | |
|---|---|---|---|---|---|
| Evaluation 2 | Compressive modulus | 7.8 | 8 | 7.3 | 4.7 |
| | (MPa) | | | | |

As can be seen from Table 1, in Examples 1-1 to 1-3, the temperature rise was slow, and the compressive modulus was high, as compared with Comparative Example 1-1.

In Evaluation 1, the thermal conductivity of each of the spacers of Example 1-1, Example 1-2, and Example 1-3 after heating decreased to less than 1.0 times the thermal conductivity before heating.

Evaluation Method 3 While applying a pressure of 2.5 MPa along the thickness direction, one surface of each of the spacers produced in Examples was heated to 200° C., and it was evaluated whether or not liquid outflow from the inside to the outside was observed during heating, or whether outflow of a solid content other than a powder in a trace amount was observed.

The case where no outflow was observed was evaluated as “very good”, the case where a trace amount of outflow was observed was evaluated as “good”, and the case where outflow was observed and continuation of heating was difficult was evaluated as “bad”.

### Evaluation Method 4

The spacers produced in Examples were evaluated for heat insulation by using a test apparatus shown in FIG. 10.

Specifically, a spacer 1 was placed on a brass metal plate 403 having a thickness of 1 mm, and a brass metal block 402 having a thickness of 5 mm was set on the upper portion of the spacer 1. The metal plate 403, the spacer 1, and the metal block 402 were covered with a heat insulating material 401 except for the lower portion of the metal plate 403.

Nitrogen gas at 300° C. heated by two tube heaters 404 was blown to the metal plate 403 from below, and the temperature of the metal block positioned above the spacer 1 was measured. The evaluation of the measured temperature was performed by setting the time of 100° C.±5° C. as the time of the plateau region.

Both evaluation results are shown in Table 2.

### Example 2-1

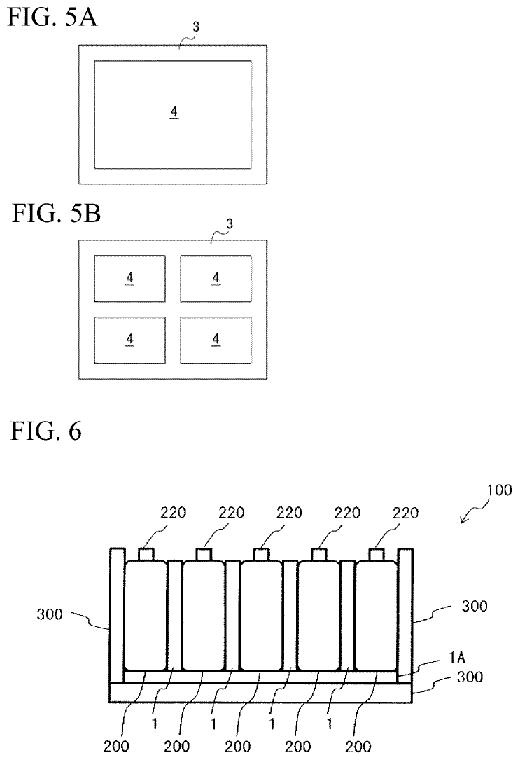

A bottomed tray-shaped member (buffer member) 3 as shown in FIG. 4B and FIG. 5B was prepared by a vacuum molding method using a polypropylene sheet having a thickness of 0.3 mm as a holding portion of an including element 2 constituting a spacer 1.

The tray-shaped member 3 had a length of 60 mm and a width of 120 mm, the shape of the lowest portion of the concave portion of the tray-shaped member 3 was a square of 7.79 mm×7.79 mm, and the depth was 1.5 mm.

Next, as shown in FIG. 4B, the concave portion of the tray-shaped member (buffer member) 3 was filled with a calcium silicate paste (heat conduction control member 4) to constitute an including element.

The depth of the concave portion of the tray-shaped member (buffer member) 3 and the thickness of the heat conduction control member 4 to be filled were set as shown in Table 2 described later. That is, the heat conduction control member 4 was formed to have a height of 1.0 mm from the bottom of the concave portion having a depth of 1.5 mm, and a void 5 having a depth of 0.5 mm was formed above the heat conduction control member 4.

The area ratio of the holding portion to the total area of the heat conduction control member 4 and the tray-shaped member (buffer member) 3 in a plan view of the spacer 1 in the thickness direction in a state where the heat conduction control member 4 was formed in the concave portion was 39% to the entire area.

The including element in which the heat conduction control member 4 was formed in the concave portion of the tray-shaped member (buffer member) 3 was disposed inside the including element using an aluminum laminate film (including polyethylene terephthalate (outer side) having a thickness of 0.012 mm, nylon (inner side) having a thickness of 0.015 mm, and polypropylene (innermost side) having a thickness of 0.06 mm as resin layers) as an outer package 2, and sealed using a vacuum deaeration sealer to obtain a spacer 1.

The calcium silicate paste as the heat conduction control member 4 was prepared as follows.

### (Calcium Silicate Paste)

To 9 g of water, 0.09 g of sodium carboxymethyl cellulose was added and kneaded at room temperature for 30 minutes using a mixer. To this, 0.5 g of calcium silicate was added and kneaded at room temperature for 5 minutes using a stirring rod to obtain a slurry. To this slurry, 3.4 g of calcium sulfate and 1.7 g of alumina cement were added and a calcium silicate paste was obtained.

### Example 2-2

A spacer 1 was obtained in the same manner as in Example 2-1 except that, in Example 2-1, the depth of the concave portion of the tray-shaped member (buffer member) 3 as the holding portion was set to 1.3 mm, the heat conduction control member 4 was formed to a height of 1.0 mm from the bottom of the concave portion, and the void 5 of 0.3 mm was formed above the heat conduction control member 4.

### Example 2-3

A spacer 1 was obtained in the same manner as in Example 2-1 except that, in Example 2-1, the depth of the concave portion of the tray-shaped member (buffer member) 3 as the holding portion was set to 2.0 mm, and the heat conduction control member 4 prepared without using a material cured by a hydration reaction was formed to a height of 2.0 mm from the bottom of the concave portion.

TABLE 2

| | | Example 2-1 | Example 2-2 | Example 2-3 |
|---|---|---|---|---|
| Height (mm) of heat conduction control layer | | 1.0 | 1.0 | 2.0 |
| Height (mm) of buffer member | | 1.5 | 1.3 | 2 |
| | Inorganic particles | Calcium silicate | Calcium silicate | Calcium silicate |
| | Binder | Calcium sulfate | Calcium sulfate | None |
| Evaluation 3 | Shape retention property | very good | very good | — |
| Evaluation 4 | Plateau region (sec) | 412 | 403 | 214 |

From the results of Evaluation 3, as shown in Examples 2-1 and 2-2, it was found that the spacer in which the thickness of the buffer member was larger than the thickness of the heat conduction control member or the spacer in which the heat conduction control member contained the binder had excellent shape retention property at a high temperature.

The spacer of Example 2-3 was not evaluated as Evaluation 3.

In addition, from the results of Evaluation 4, it was found that the spacer containing the hydration product had a longer plateau region in the temperature rise process. The longer the plateau region is maintained, the longer time is required for evaporation of water inside, and thus the longer time is required for heat transfer in an abnormal state.

In Evaluation 3, the thermal conductivity of each of the spacers of Example 2-1, Example 2-2, and Example 2-3 after heating decreased to less than 1.0 times the thermal conductivity before heating.

The thicknesses of the spacers produced in Example 2-1 and Example 2-2 were evaluated when a pressure of 0.2 MPa was applied to the spacers. When the deformation rate (%) with respect to the thickness when no pressure was applied was evaluated, the deformation rate of the spacer of Example 2-1 was 30%, and the deformation rate of the spacer of Example 2-2 was 19%.

The thicknesses of the spacers produced in Example 2-1 and Example 2-2 were evaluated when a pressure of 1.0 MPa was applied to the spacers. When the deformation rate (%) with respect to the thickness when no pressure was applied was evaluated, the deformation rate of the spacer of Example 2-1 was 57%, and the deformation rate of the spacer of Example 2-2 was 48%.

### INDUSTRIAL APPLICABILITY

The spacer of the present invention exhibits, in a normal state, good elasticity and pressure resistance and can efficiently transfer heat generated from an adjacent unit battery to a neighboring unit battery. In addition, in an abnormal state in which an adjacent unit battery is damaged and there is a risk that the damage may spread to the entire assembled battery in a chain reaction, it is possible to prevent the chain reaction of the damage between the unit batteries.

Therefore, the assembled battery using the spacer of the present invention is promising as a highly safe secondary battery, for example, as a power source for vehicles, even if it has a high energy density.

What is claimed is:

1. A spacer comprising a heat conduction control member, a buffer member, and an outer package for housing the heat conduction control member and the buffer member.

2. The spacer according to claim 1, wherein the spacer has a thermal conductivity of 0.25 [W/(m·K)] or more when an average surface temperature of the spacer is 25° C.

3. The spacer according to claim 2, wherein the spacer has a deformation rate under a pressure of 0.2 MPa of 5 to 50%.

4. The spacer according to claim 2, wherein a thickness of the heat conduction control member is equal to or less than a thickness of the buffer member.

5. The spacer according to claim 1, wherein the heat conduction control member is made of a composition containing at least one selected from the group consisting of inorganic particles and inorganic fibers and a liquid, or a cured product of the composition.

6. The spacer according to claim 5, wherein the heat conduction control member further comprises a binder.

7. The spacer according to claim 5, wherein the heat conduction control member further comprises a hydration product.

8. The spacer according to claim 5, wherein a content of the liquid is 1 to 90% by mass with respect to a total mass of the composition.

9. The spacer according to claim 5, wherein the inorganic particles are at least one selected from the group consisting of calcium silicate and zeolite.

10. The spacer according to claim 5, wherein the buffer member is a sheet-shaped member and has a concave portion and/or a penetration portion, and the concave portion and/or the penetration portion is provided with the composition or a cured product thereof.

11. The spacer according to claim 5, wherein the buffer member is a tray-shaped member having a plurality of concave portions, and the concave portions are filled with the composition.

12. The spacer according to claim 1, wherein the buffer member is made of a thermoplastic polymer.

13. An assembled battery comprising a plurality of unit batteries, and the spacer according to claim 1 between the unit batteries.

14. The assembled battery according to claim 13, wherein when the unit battery thermally expands, the unit battery comes into contact with the buffer member and the heat conduction control member of the spacer in this order via the outer package.

15. A spacer comprising a heat insulating material precursor and an outer package for housing the heat insulating material precursor.

16. The spacer according to claim 15, wherein the heat insulating material precursor contains at least one selected from the group consisting of inorganic particles and inorganic fibers, and a liquid.

17. The spacer according to claim 15, wherein the heat insulating material precursor becomes a heat insulating material by heating.

18. An assembled battery comprising a plurality of unit batteries and a member disposed between the unit batteries, wherein a portion between two unit batteries includes a unit satisfying the following conditions (1) and (2):
(1) an average surface temperature of the two unit batteries is 50 to 200° C., and a thermal conductivity decreases to less than 1.0 times;
(2) a deformation rate of the member disposed between the two unit batteries is 5 to 50% with respect to a pressure of 0.2 MPa applied between the two unit batteries.

19. The assembled battery according to claim 18, wherein the member disposed between the unit batteries includes a heat conduction control member.

20. The assembled battery according to claim 18, wherein the member disposed between the batteries includes a heat insulating material precursor.
